(19) United States
(12) Patent Application Publication
(10) Pub. No.: US 2010/0102573 A1
(43) Pub. Date: Apr. 29, 2010

(54) Retrofit safety door lock

(76) Inventor: Joseph Rancatore, Lincoln, CA (US)

Correspondence Address: William S. Bernheim, 255 N. Lincoln St., Dixon, CA, 95620, US

(21) Appl. No.: 12/288,767

(22) Filed: Oct. 24, 2008

(51) Int. Cl. E05B 65/10

(52) U.S. Cl. 292/93; 292/147

(57) ABSTRACT

The invention involves the creation of a security lock system that allows a room's occupant to quickly secure the room against entry from the outside without the need to exit the room and without the need to use a key for activating the lock mechanism; the lock is a retrofit device that fits onto a typical inner lever arm door handle, and provides a frictional means for maintaining the inner door handle in an open position; in an emergency, the handle can be manually rotated into the closed, position, rendering the door non operable from outside without the use of the appropriate key.

### BACKGROUND OF THE INVENTION

1. Field of Invention

The invention relates to a device that allows for locking the door to a room via the interior handle in a manner that prevents entry from the exterior during an emergency “shut down” situation when the room's occupants are exposed to possible danger from outside the room. More particularly, it relates to a retrofit device that is easily and quickly installed on existing latch type door handles, does not require the use of a key for its engagement, takes only seconds to activate, is activated from the interior of the door, and is inexpensive compared to prior art versions of so called “Columbine” locks.

2. Description of the Relevant Prior Art

Following the horrendous shooting deaths at Columbine High School in 1999 and other such tragedies such as the Virginia Tech shootings, there has been increased public interest in protecting students from such dangers. In the past, School room doors could only be locked and unlocked by a key placed into the door from outside the room. In a room having such a lock, if a dangerous situation developed, the teacher or other school personnel would have to locate their key, go out of the room into a typically common area in order to lock down the room and protect the students within. Doing this takes time and exposes the person who went out to lock the door to an assailant or to what ever external threat exists. If that person was harmed, the room would be open to entry by the assailant, placing the students at risk.

One of the changes that resulted following the Columbine tragedy was the mandate that old style “knob” handle locks sets were to be phased out and only lever handle type locksets were to be used in any new school room construction, and, the lock sets were to be lockable from both within and outside the room. The expense of replacing old locks with the new type lock not only involves the increased costs of the new style lock, but also involves the labor expense of removing the old lock and replacing it with the new model.

The cost can be prohibitive, especially for less affluent school districts. As an example, newspaper reports stated that when the San Mateo Union High School District in Northern California decided to install such locks on classroom doors, the cost was $263,095.00 for placing the locks in approximately 581 doors; a cost of just over $450.00 per door.

The lock disclosed in U.S. Pat. No. 5,562,317, a lockset requiring the replacement of an existing lock, makes it such that once the external lever handle lock is disengaged and the room has been entered, the inner handle assembly can be used to manually lock the door from the inside. This prevents the need to open the door and then lock it from outside the room. In the system disclosed by the above mentioned patent, the internal lock unit is not directly interconnected to the external key-lock cylinder. Lockdown, using the inner handle is accomplished as follows: a button projecting outward in a radial direction from the door surface through a hole in the mounting cap of the inner handle is pressed inward towards the door. When that button is pressed in, it pushes a locking shaft across into a recess in the external handle's lock mechanism, and thus restricts the rotation of the outside lever handle, preventing opening of the door from the outside. The internal handle assembly also has a mechanism that disengages the locking shaft and retracts it back out of the outer handle lock mechanism when the inner handle lever is rotated back to the horizontal position; thus releasing the locket's latch bolt from the strike plate recess and allowing the door to be opened from either side.

The major drawbacks of this system include: 1. The cost of purchasing the new lockset, removing the old set and then installing the new set; 2. The labor involved in adjusting the new set to work at the thickness of the door in which it is being mounted; and 3. Because of the complexity of the activating and de-activating system, there is a likelihood of greater maintenance costs associated with frequent opening and closing of the door.

The lock disclosed in U.S. Pat. No. 5,083,823, also a lockset requiring the replacement of an existing lock, provides for internal locking of the door as a safety feature, and is designed with a telescoping spindle such that doors of differing width can be accommodated by one model of the lockset. The invention utilizes a locking shaft that originates as a button projecting internally through a hole in the internal handle's mounting plate. From its origin, the shaft continues through the central lock section parallel to but offset from the lever handle axles that operate the lock's throw latch. The shaft terminates in a constricted end that passes through a hole in the spring loaded rotary plate that actuates the latch bolt when the external handle is depressed, thus preventing the external handle from being depressed and preventing opening from the outside.

As with the lock disclosed in U.S. Pat. No. 5,562,317, the invention of U.S. Pat. No. 5,083,823 also suffers from several problems. The major drawbacks of this latter system include: 1. The cost of purchasing the new lockset, removing the old set and then installing the new set; 2. The likelihood of greater maintenance costs resulting from the complexity of the throw latch activating system; and 3. the internal and external mounting plates must be precisely situated relative to each other in order to allow the locking shaft to be aligned properly between the internal and external door handle assembly sections; this results in increased cost of labor and, if not properly executed, the likelihood that the mechanism will either not work, or will wear out quickly because of increased frictional wear on an “O” ring that provides the frictional resistance necessary to keep the lock shaft in the lock-engaged position.

Another commercially available solution to the schoolroom security problem is the Schlage Series ND75 PD lockset system. These locks have double lever handles, and they can be locked from either side. The inner handle lock has an emergency release that allows unlocking from the inside without the key if the need should arise. The major problems involved with using these locks include: 1. The cost of purchasing the new lockset, removing the old set and then installing and adjusting the new set to work at the thickness of the door in which it is being mounted; and 2. Maintenance costs associated with frequent opening and closing of the door; 3. The delay time involved in finding and using the key on the internal lock in an emergency situation.

Thus it is seen that the prior art suffers from the high cost of replacing door locksets, the possibility of maintenance problems associated with more complex lock systems, and in the case of internally keyed locks, the need to find the key quickly in an emergency situation. The keyed version also suffers from the danger of a jammed internal key hole due to vandalism. Neither style gives an immediate visual indication of whether the internal lock mechanism is engaged or disengaged.

### Statement of the Objectives

In accord with the need for allowing rapid lockdown of a room when external danger threatens the occupants of that room, it is an object of this invention to provide the following benefits:

It is a primary object of this invention to allow the responsible party to lock the door without being exposed to the external danger by virtue of being able to lock the door from within the room itself.

It is another object of this invention to allow the internal locking to be performed without the need to locate and use a key for the locking process.

It is a further object to provide an inexpensive alternative to a double locked system; creating a savings of up to 66% or more over the cost of prior art systems, the savings being accomplished by the use of a retrofit device that is compatible with most existing lever handle lock sets; thus eliminating the need to remove or replace existing single cylinder lever handle locks that are already in place.

It is another object to provide a lock system that requires no special carpentry or mechanical skills; that can be installed in minutes; and that requires very little adjusting, resulting in a lower installation costs.

Another object is to provide a system providing a security lock having reduced maintenance costs, and, that also reduces wear and tear on the existing lock set because of a decreased need to activate door lever handle mechanisms when entering or exiting the room during regular daily activities.

Another object is to provide a vandalism free mechanism that cannot be jammed short of extreme efforts involving the use of heavy tools.

Another objective is to provide a system that allows the observer to visually confirm whether the internal lock is engaged or not simply by looking at the position of the internal lever handle.

Other objectives, advantages and novel features of the invention will become apparent to those skilled in the art upon examination of the invention and the accompanying drawings.

### SUMMARY OF THE INVENTION

The invention involves the creation of an aluminum, split-frame casting (“unit”) that can be mounted as a retrofit device on the horizontal axle of an externally lockable lever handle lock set, thereby converting the lockset into a safety lock that can be locked from within, without exiting the room and without the use of a key if danger threatens the occupants of the room.

The unit comprises two half-cylinders of equal dimensions and radii placed together so as to form a tubular element formed of, upper and lower cylindrical side wall sections both having a smooth outer surface and a uniform thickness excepting in specific areas of columnar thickening of the side wall sections which thickened areas give the interior aspect of the side walls an irregular conformation; the cylinder side wall being of a width allowing it's mounting on the axle shaft of an existing lock set in between the inner aspect of the internal lever handle and the rosette of the lockset's mounting assembly; the externally facing end of each of the cylindrical half-walls being affixed to a perpendicular face plate section that is planar with the interior surface of the door and that partially closes off the end of the cylinder furthest from the door surface.

The upper and lower sections of the cylindrical side wall of the unit are permanently joined at one end by a hinge assembly, and, with the hinge in the closed position, an Allen head cap screw assemblage at the opposite radial extreme of the side wall can be used to lock the upper and lower sections together.

Once thus locked, the unit appears as a cylinder open at one end and having at the opposed end, a face plate bearing an ovoid shaped cutout designed to allow securely fitting and holding the unit around the various sized horizontal connecting axles of most lever type door handles.

Four Allen head threaded set screws that are located within the columnar swellings in the side wall of the unit, are capped by adjustable urethane “brake” pads that terminate planar to and at the level of the inner face of the unit's peripheral side wall; the pads can be made to project beyond the inner face of the unit by adjustment of set screws, thus making frictional contact with the lock set's rosette; the contact of the brake pads against the rosette provides enough anti-rotational friction to hold the internal door handle in a rotated downward position after it is manually moved downward from its usual horizontal position; with the effect that the latch-bolt is held out of the strike plate recess of the door jamb, thus placing the door in a free swinging mode for so long as the internal handle is left depressed from the horizontal position.

The door is free swinging with the internal handle held in the depressed position, eliminating the need to use the latch mechanism repeatedly when passing through the door. The readiness of the safety lock is clearly visible throughout the day by virtue of the depressed position of the internal lever handle of the door.

When activated, the assembly allows rapid lock-down of the room to protect its occupants from an external threat. The responsible person needs merely walk to the door and elevate the internal handle to the horizontal position and the door cannot be opened from the outside without the appropriate key. The lockdown is done safely from within the room and without the need to use a key for the activation of the lock.

Once the danger has passed, the door can be opened from within simply by downward rotation of the internal lever handle to its fully depressed position

### BRIEF DESCRIPTION OF THE DRAWINGS

FIG. 1 Presents a perspective view of the outer face plate of the retrofit safety lock invention (“unit”), showing the face that is planar with and furthest removed from the inner face of the door, and portions of the upper and lower split-side-wall sections.

FIG. 2 Presents a cross sectional view looking down onto and from the aspect of the inner most face of the unit, the side that is planar with and closest to the inner face of the door or rosette.

FIG. 3 Presents a perspective view of the unit in place on the horizontal-axle (“shaft”) of the inner door handle, with the handle lever arm in the normal horizontal position and the throw latch in a fully extended position.

FIG. 4 Presents a perspective view of the unit in place on the shaft of the inner door handle. In this instance, the inner handle lever arm is rotated downwards, where it is held by the frictional resistance of the urethane brakes that exert pressure against the rosette of the door lock. The throw latch is seen in a retracted, free swinging position.

FIG. 5 Presents a diagrammatic view of the hinge assembly as viewed from the hinge-end peripheral side wall.

FIG. 6 Presents a diagrammatic view of the mounted unit's brake pads extended to contact the lock set's rosette.

### DETAILED DESCRIPTION OF A PREFERRED EMBODIMENT

As shown in Fig. One, the invention involves the creation of a split frame circular aluminum housing (“unit”) 1 comprising a section of a cylinder, having an upper section 101 and a lower section 102, the upper and lower sections 101 and 102 being connected by a hinge assemblage 11; comprising a hinge pin 12 that passes sequentially through a hole 120 in an outer face plate 3 of the lower section 102, then through a hole 121 in an upper section hinge tongue 13 and finally through a hole 122 in FIG. 2 in an inner side wall face plate 17 in FIG. 2 of the lower section 102.

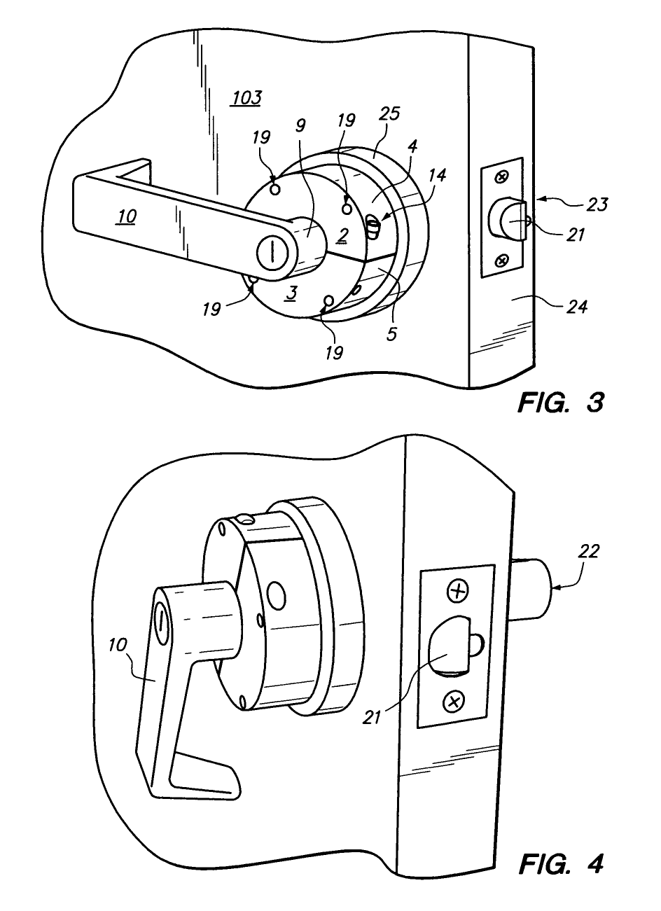

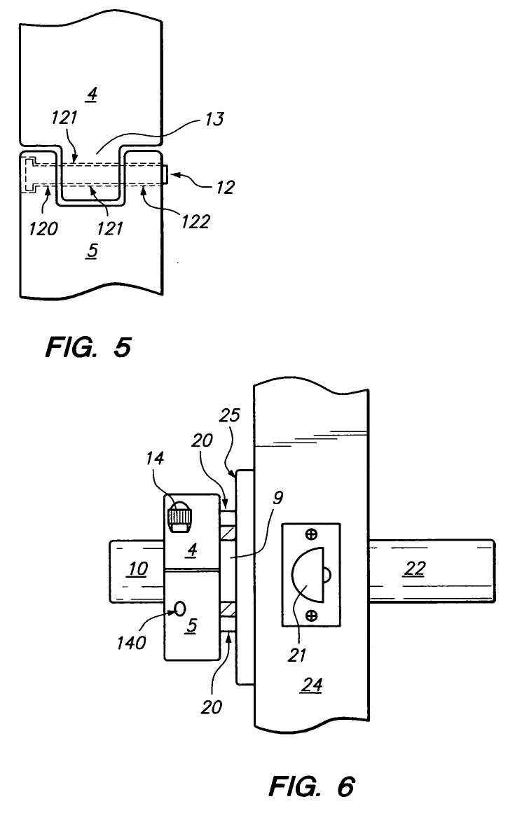

Hinge assemblage 11 is situated at one side of the unit 1 to allow its opening and closing for the purposes of its installation around a horizontal shaft (“axle”) 9 in FIG. 3 connecting an inner door lever handle 10 in FIG. 3 to the lock cylinder mechanism (not shown) of an existing lock set.

For the purpose of creating a fixed rotational relationship between the unit 1 and the inner door handle 10 in FIG. 3; once the unit 1 upper and lower sections 101 and 102 are closed down together, a locking arrangement involving a lock-bolt 14, the head of which is located in upper section 101, is screwed down into a cap screw threaded receptacle 140 located in upper section 101 and then into a continuation as that same threaded receptacle 140 in lower section 102 of the unit 1; thus making the unit 1 fast to the axle shaft 9 in FIG. 3 of the door's internal handle 10 in FIG. 3 such that downward rotation of inner door handle 10 in FIG. 3 rotates the unit 1 downward to that the same degree, and where both are held by virtue of the frictional based safety lock mechanism of the invention the physical mechanism of which is to be described later, a position best seen in FIG. 4.

Upper section 101 has an outer face section 2 that is perpendicular to and connected to an upper peripheral side wall 4, and the lower section 102 has an outer face section 3 that is perpendicular to and connected to a lower peripheral side wall 5.

The combined outer face sections 2 and 3 are pierced by an ovoid shaped central cutout 6 that is bounded above by an upper central side wall 7 in FIG. 2 and below by a lower central side wall 8; both upper and lower peripheral side wall sections 4 and 5 being of a width that allows fitting the unit 1 between the inner aspect of the lever handle 10 of an existing door lock set and the parallel surface of a rosette section 25 in FIG. 3 of the door lock set (as best seen in FIG. 6); the ovoid cutout 6 has its end of lesser radius adjacent to the hinge 11 side of the unit 1; the cutout 6 being eccentrically situated within the outer face of the upper and lower sections 2 and 3 such that the lock bolt 14 end, the end of the greater radius, is situated further from the unit's 1 side walls 4 and 5 than is the end of the cutout 6 that is situated closest to the hinge 11 end of the unit 1; that arrangement being designed to allow fitting of the retrofit safety lock unit 1 around the axles 9 in FIG. 3 of lock sets having differing axle 9 circumferences;

Turning now to view FIG. 2, an internal face 16 of the upper section side wall 4, and the internal face 17 of the lower section side wall 5, which face and lie parallel to the internal surface of a door 103 in FIG. 3, are perpendicular to the upper and lower section 101 and 102 peripheral side walls 4 and 5, generally being of the same peripheral outlines, internal outlines and thicknesses as are peripheral side walls 4 and 5;

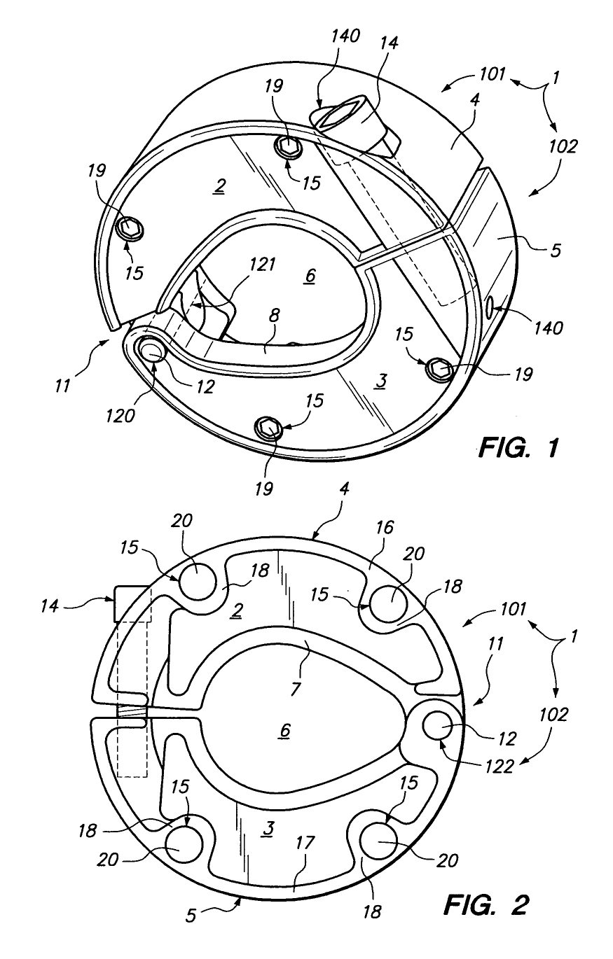

A series of four projections 18, situated two apiece in the upper section and lower section 101 and 102, and being spaced approximately equidistantly around the periphery of the unit 1, represent cross sectional partial thickening of the side walls 4 and 5 in towards the central opening of the unit 1; these four projections 18, spaced two to a side in the upper and lower sections 101 and 102 of the unit 1 contain partially threaded holes 15 the outer ends of which holes 15 in FIG. 1, each holds a small Allen wrench adjustable set screw 19 in FIG. 1, the set screws 19 in FIG. 1, having their wrench socket ends located in the unit's 1 upper and lower face plates 2 in FIGS. 1 and 3 in FIG. 1 and their rounded, internally facing ends (not visible) terminating against the central most end (not visible) of adjustable Urethane pads 20 the external most end of which urethane pads are initially flush with the internal face of the projections 18 within which they are otherwise encased; these urethane pads being of a diameter slightly less than that of the non-threaded sections of holes 15 within which they lie and which pads serve to form a series of four adjustable brakes that can be made to project externally beyond the inner face plates 16 and 17 of upper and lower sections 101 and 102 respectively towards the door lock set mechanism's rosette 25 as best seen in FIG. 6, which action is made to happen by screwing in the adjustable set screws 19 in FIG. 1 such that the internal end surfaces of the urethane pads 20 in FIG. 6 can be moved towards the inner door surface 103 in FIG. 6 until the outer aspect of the pads 20 in FIG. 6 are brought into contact with the face of the lock sets inner rosette 25 in FIG. 6, the contact pressure so created providing an anti rotational frictional resistance allowing of keeping the internal lock set lever handle 10 in FIG. 6 rotated fully downward once it is manually so moved from the horizontal plane; the frictional anti-rotational resistance of those pads 20 in FIG. 6 serving as a brake mechanism having adequate frictional resistance as well to hold a lockset's latch-bolt 21 in FIG. 4 withdrawn from the well of the door jamb's Strike plate (not shown), and the door being thus made free swinging such that it can be opened and closed without the use of either the inner door lever handle 10 in FIG. 3, 4 or an outer door lever handle 22 FIG. 4; the anti-rotational frictional resistance of the brakes 20 in FIG. 6, being adjustable such that the internal door lever handle 10 in FIG. 3 can readily be manually returned to its normal horizontal position, the position in which the door's latch-bolt 21 in FIG. 3 is in an extended position as seen at 23 FIG. 3, the position in which it latches into and lies within the confines of the door's strike plate (not shown) when a door's jamb facing surface 24 in FIG. 3 is brought into alignment with the door-jamb itself.

In daily use, in order to be emergency ready, the mounted and pre-adjusted retrofit lock assembly is used in the following manner. The word “party” as used in the following section refers to the responsible person having the keys and the authority to lock and unlock the room.
1. Party approaches and unlocks the outer lock with a key
2. the key is left in the outer lock, the door is opened and party enters the room
3. the key is turned back to the locked position;
4. party moves the internal lever handle 10 in FIG. 4 down fully towards the floor
   (the frictional resistance of the brake system's urethane pads 20 in FIG. 4 holds that handle in the depressed position, thus keeping the door latch-bolt 21 in FIG. 4 out of the strike plate cutout (not shown), leaving the door in a free swinging mode, where it remains, visibly, in the unlocked mode throughout the day.)
5. Party then removes the key and places it in a safe place.
6. In an emergency, party moves to the door and elevates the internal lever handle 10 in FIG. 3 back to the horizontal position
7. The door is locked at that point and cannot be opened from outside without the appropriate key.

I claim:

1. A frictionally active safety door lock assembly comprising a split housing hinged at one end and having means for securing the opposite end of said split housing to form a unit capable of being placed over and securely retrofitted onto an axle of an internal lever handle of a door in that class of doors and lock assemblies typically found in educational facilities, in which said door can only be locked by a key placed into an external door handle, and in which a non-lockable lever arm handle is located internally;
and in which a latch-bolt of said lock is prevented from being retracted from a door jamb's strike plate recess when said door is locked and is moveably biased towards extension into said recess when said lock is unlocked;
a means whereby adequate anti rotational frictional resistance to overcome a lock set's bias towards extension of its latch-bolt is provided, said means being adjustable to create an anti-rotational frictional resistance capable of holding said internal lever arm handle in a downward position, while not providing so great a resistance that it prevents a teacher or a student from manually moving said internal lever handle either downward from its normal horizontal position or from returning said lever handle to its original position;
said locking means serving to hold said latch-bolt in a retracted position such that said door is free swinging and entry and exit can be negotiated without use of either of said handles if; after initially unlocking said external cylinder lock by said key, a responsible party opens said door, and with said key kept in place in the locked position, holds said door open, removes said key while the lock is in the locked position then fully depresses said internal lever handle;
said locking means also providing that should said door subsequently be closed and said internal lever handle be moved back up to its original position, said latch-bolt is released and re-extends into said strike plate recess with said lock mechanism remaining in a locked status, thus preventing external access to the room other than by the use of an appropriate key.

2. The securing means of the split housing assembly of claim 1. comprising the use of a bolt which passes vertically downward from a bolt-cap recess in an upper section of a split housing and then through a bolt hole in said upper section following which it passes into and is engaged within the threads of a bolt hole in an inferior section of said housing where the two sections approximate each other, or alternatively, in reverse fashion, said bolt assemblage passing from below upward between said lower and said upper housing elements.

3. The means of providing anti rotational frictional resistance of claim 1 comprising the use of four adjustable brake pad assemblages, which said break pad assemblages are located within partially threaded tubular hollows (“hollows”) spaced two to a side within the exterior side wall portions of said upper and lower sections of said split housing of said safety door lock assembly; said brake pad hollows being longitudinally aligned at a perpendicular to the rosette of said internal lever arm door handle and being adjustable over time to maintain an adequate frictional contact with said rosette;

4. The housing of claim 1 comprising a tubular element formed of two half sections of matching radii, lengths and wall thickness, said sections being permanently affixed at one side wall juncture by a hinge and pin mechanism, and capable of being secured together at the opposite side wall juncture by tightening a bolt assemblage that passes from one hemi-cylinder to the other; both said hemi-cylinders having a perpendicularly placed face plate that peripherally conforms to the outline of the associated hemi-cylinder section; when the faces of said hemi cylinders are brought together, there exists an eccentrically placed ovoid shaped cutout (“cutout”) that is situated such that the end of said cutout having the lesser radius is closer to said hinge end than is the distance between the opposite end of said ovoid and the adjacent locking means of said split housing sections.

5. A process for performing the safety lockdown of a classroom door utilizing a split casting retrofit safety lock that has been securely affixed around an axle of said door's internal lever handle; the following sequence of steps being involved in said process:
1. A responsible party (“party”) approaches and unlocks an outer lock cylinder with a key
2. said key is left in position in said outer lock cylinder's keyhole and said door is opened, following which said key is returned to the locked-door position and
3. keeping said door open, said party enters the room and turns said internal lever handle down towards the floor, a position in which it is held by the invention.
4. Said party then allows said door to close and removes said key and places it in a safe place in the room.
5. Despite said lock itself being in a locked status, said door remains in a free swinging mode, neither said internal nor said external lever arm handles need be used to pass into or from the room because said lock's latch-bolt is held inactive by the invention.
6. In an emergency situation, responsible party moves to said door and returns said door's internal lever handle to the horizontal position, automatically returning said latch bolt into said strike plate recess.
7. At that point, said door is locked and cannot be opened from outside without the appropriate said key.
8. When the all clear is given said internal handle can once again be used to open said door and allow access into and out from the room.
